(19) United States
(12) Patent Application Publication
(10) Pub. No.: US 2008/0211964 A1
(43) Pub. Date: Sep. 4, 2008

(54) Automatic Tv Standard Determination Method and Apparatus Thereof

(75) Inventor: Jian Xiong, Guangdong (CN)

Correspondence Address: NORTH AMERICA INTELLECTUAL PROPERTY CORPORATION, P.O. BOX 506, MERRIFIELD, VA, 22116, US

(73) Assignee: Media Tek (ShenZhen) Inc., ShenZhen (CN)

(21) Appl. No.: 11/910,738

(22) PCT Filed: Apr. 8, 2005
(86) PCT No.: PCT/CN05/00468

§ 371 Date: Jan. 22, 2008

(51) Int. Cl. H04N 5/46

(52) U.S. Cl. 348/555; 348/E05.114

(57) ABSTRACT

An apparatus for automatically determining a TV standard of a TV channel comprises a frequency identification module and a determination module. The frequency identification module identifies a carrier frequency of an audio IF signal of the TV channel to generate a frequency identification result. The determination module, which coupled to the frequency identification module, determines the TV standard of the TV channel according to the frequency identification result.

### BACKGROUND OF THE INVENTION

1. Field of the Invention

The present invention relates to television (TV), and more particularly, to a method for automatically determining a TV standard of a TV channel and an apparatus thereof.

2. Description of the Related Art

Currently, National Television Standards Committee (NTSC) and Phase Alternating Line (PAL) are two kinds of widely applied color systems. Examples of TV standards utilizing the PAL color system include a PAL-B/G standard, a PAL-I standard, and a PAL-D/K standard. In different countries, different PAL standards may be used. Even in a single country, it is also possible to utilize different PAL standards in different TV channels.

When watching a TV or using an AV decoder, users have to first set a corresponding TV standard for a channel in order to receive audio and video signals in a correct manner. The AV decoder may be a DVD player, DVD recorder, or any other device decoding the TV signal. Traditionally, a TV standard is manually selected from a variety of support standards and a target channel can be set accordingly. If the TV standard of a TV channel is not correctly set, the TV or AV decoder cannot receive a correct audio signal from the TV channel. This leads to incorrect playback of the TV channel. However, it is very inconvenient for users to set a TV standard manually.

### SUMMARY OF THE INVENTION

An exemplary embodiment of an apparatus for automatically determining a TV standard of a TV channel comprises: a frequency identification module for identifying a carrier frequency of an audio inter-frequency (IF) signal of the TV channel and generating a frequency identification result; and a determination module coupled to the frequency identification module, for determining the TV standard of the TV channel according to the frequency identification result.

An exemplary embodiment of a method for automatically determining a TV standard of a TV channel comprises: receiving an audio IF signal of the TV channel; identifying a carrier frequency of the audio IF signal; and determining the TV standard of the TV channel according to a frequency identification result of the identifying step.

### BRIEF DESCRIPTION OF DRAWINGS

FIG. 1 shows a block diagram of an exemplary embodiment of an apparatus for automatically determining a TV standard of a TV channel.

FIG. 2 shows a schematic diagram of an exemplary embodiment of the IF amplifier and frequency identification module illustrated in FIG. 1.

### DETAILED DESCRIPTION OF THE PREFERRED EMBODIMENTS

In practice, audio second IF signals of the PAL-B/G, PAL-I, and PAL-D/K standards correspond to different carrier frequencies. For example, a standard audio carrier frequency is located at 5.5 MHz for the PAL-B/G standard, at 6 MHz for the PAL-I standard, and at 6.5 MHz for the PAL-D/K standard. It is feasible to exploit this characteristic to automatically determine which TV standard a TV channel utilizes. In other words, when receiving an audio second IF signal of a TV channel, exemplary embodiments described here identify a carrier frequency of the audio second IF signal and thereby determine a TV standard of the TV channel. In this way, manual procedures are reduced, thus eliminating the inconvenience caused by manually setting a correct TV standard.

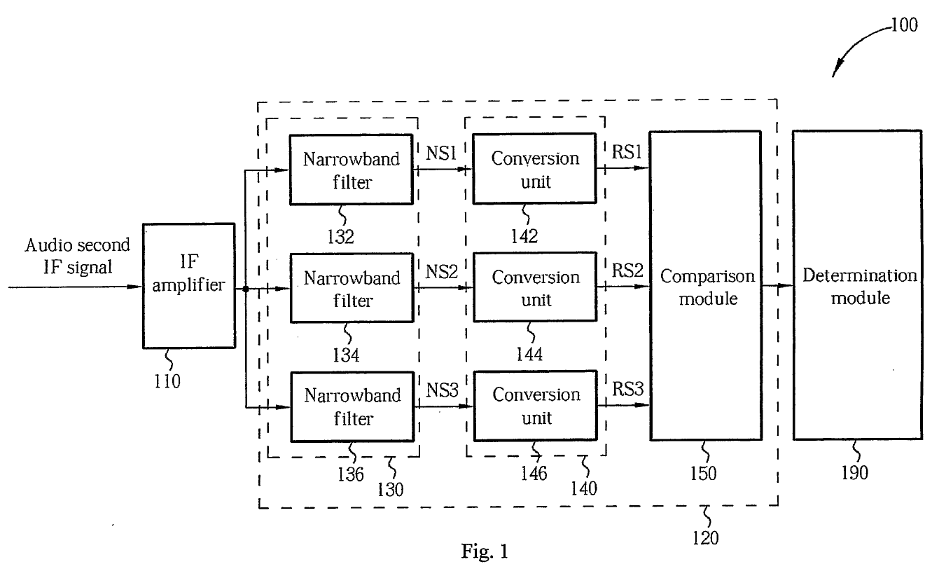

FIG. 1 shows a block diagram of an exemplary embodiment of an apparatus 100 for automatically determining a TV standard of a TV channel. As depicted, the apparatus 100 comprises an IF amplifier 110, a frequency identification module 120, and a determination module 190. The IF amplifier 110 receives an audio second IF signal of a TV channel and amplifies the received audio second IF signal. The frequency identification module 120 then identifies a carrier frequency of the audio second IF signal of the TV channel and generates a frequency identification result accordingly. The determination module 190 determines the TV standard of the TV channel according to the frequency identification result generated by the frequency identification module 120.

In some embodiments, the frequency identification module 120 includes a filter module 130, a conversion module 140, and a comparison module 150. The filter module 130 comprises, but is not limited to, three narrowband filters 132, 134, and 136. The first narrowband filter 132 operates around a first frequency band to filter the audio second IF signal, which generates a first filtered signal NS1. The second narrowband filter 134 operates around a second frequency band to filter the audio second IF signal, which generates a second filtered signal NS2. The third narrowband filter 136 operates around a third frequency band to filter the audio second IF signal, which generates a third filtered signal NS3. For conforming to the PAL-B/G, PAL-I, and PAL-D/K standards, center frequencies of the first, second, and third frequency bands can be located at 5.5 MHz, 6 MHz, and 6.5 MHz, respectively. The conversion module 140 comprises, but is not limited to, three conversion units 142, 144, and 146. The first conversion unit 142 converts the first filtered signal NS1 into a first resulting signal RS1. The second conversion unit 144 converts the second filtered signal NS2 into a second resulting signal RS2. The third conversion unit 146 converts the third filtered signal NS3 into a third resulting signal RS3. The carrier frequency of the audio second IF signal of the TV channel is identified by examining the first, second, and third resulting signals RS1-3. Then, the TV standard of the TV channel can be determined according to the frequency identification result.

The comparison module 150 of FIG. 1 generates the frequency identification result according to the first, second, and third resulting signals RS1-3. In this regard, by comparing the first, second, and third resulting signals RS1-3 with each other, or comparing a reference signal RS0 with the first, second, and third resulting signals RS1-3, the comparison module 150 is able to generate the frequency identification result.

As mentioned above, the determination module 190 automatically determines the TV standard of the TV channel according to the frequency identification result. If the frequency identification result generated by the frequency identification module 120 shows that the carrier frequency of the audio second IF signal is around the audio carrier frequency of the PAL-B/G standard, the determination module 190 determines that the channel is operating pursuant to the PAL-B/G standard. If the frequency identification result shows that the carrier frequency of the audio second IF signal is around the audio carrier frequency of the PAL-I standard, the determination module 190 determines that the channel is operating pursuant to the PAL-I standard. If the frequency identification result shows that the carrier frequency of the audio second IF signal is around the audio carrier frequency of the PAL-D/K standard, the determination module 190 determines that the channel is operating pursuant to the PAL-D/K standard.

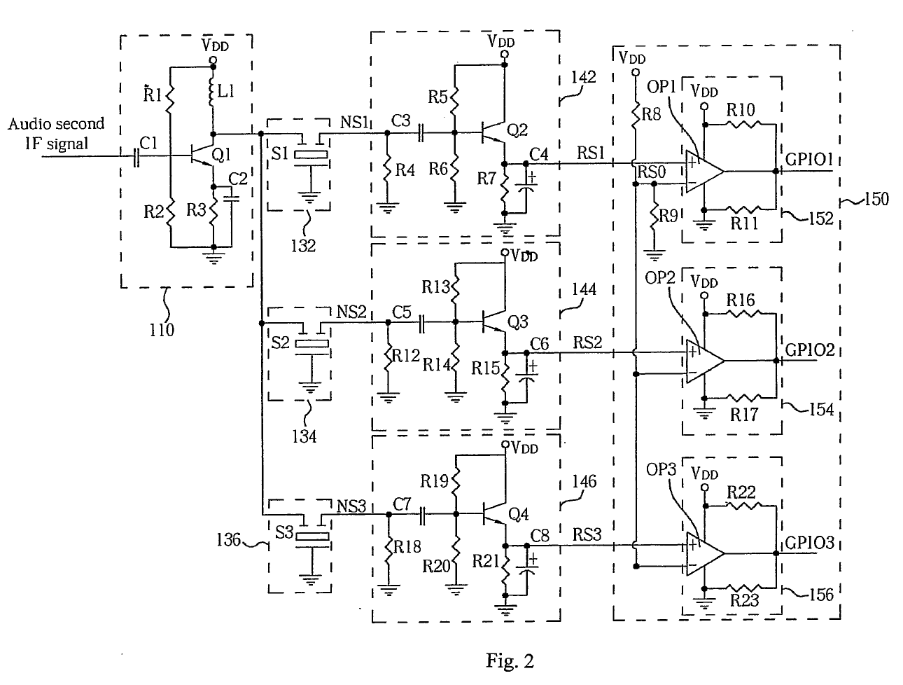

Referring now to FIG. 2, the IF amplifier 110 comprises three resistors R1, R2, and R3, two capacitors C1 and C2, an inductor LI, and a transistor Q1. The first, second, and third narrowband filters 132, 134, and 136 are surface acoustic wave (SAW) filters S1, S2, and S3 with center frequencies of 5.5 MHz, 6 MHz, and 6.5 MHz, respectively. Note that each of the resulting signals RS1, RS2, and RS3 is a DC voltage. The first conversion unit 142 includes four resistors R4, R5, R6, and R7, two capacitors C3 and C4, and a transistor Q2. If the carrier frequency of the audio second IF signal is around 5.5 MHz, the first conversion unit 142 swiftly charges the capacitor C4 to raise the first resulting signal RS1 to a high voltage level; otherwise, the first conversion unit 142 maintains the first resulting signal RS1 at a low voltage level or swiftly discharges the capacitor C4 to decrease the first resulting signal RS1 to the low voltage level. The second conversion unit 144 includes four resistors R12, R13, R14, and R15, two capacitors C5 and C6, and a transistor Q3. If the carrier frequency of the audio second IF signal is around 6 MHz, the second conversion unit 144 swiftly charges the capacitor C6 to raise the second resulting signal RS2 to the high voltage level; otherwise, the second conversion unit 144 maintains the second resulting signal RS2 at the low voltage level or swiftly discharges the capacitor C6 to decrease the second resulting signal RS2 to the low voltage level. The third conversion unit 146 includes four resistors R18, R19, R20, and R21, two capacitors C7 and C8, and a transistor Q4. If the carrier frequency of the audio second IF signal is around 6.5 MHz, the third conversion unit 146 swiftly charges the capacitor C8 to raise the third resulting signal RS3 to the high voltage level; otherwise, the third conversion unit 146 maintains the third resulting signal RS3 at the low voltage level or swiftly discharges the capacitor C8 to decrease the third resulting signal RS3 to the low voltage level.

The comparison module 150 of FIG. 2 comprises two resistors R8 and R9, and three comparison units 152, 154, and 156. The two resistors R8 and R9 are arranged in the form of a voltage divider to generate a reference signal RS0 by dividing a DC supply voltage V_{DD}. A first comparison unit 152 comprises a voltage comparator OP1 and two resistors Ri0 and R11, and compares the first resulting signal RS1 with the reference signal RS0 to generate a signal GPIO1. A second comparison unit 154 comprises a voltage comparator OP2 and two resistors R16 and R17, and compares the second resulting signal RS2 with the reference signal RS0 to generate a signal GPIO2. A third comparison unit 156 comprises a voltage comparator OP3 and two resistors R22 and R23, and compares the third resulting signal RS3 with the reference signal RS0 to generate a signal GPIO3.

The three signals GPIO1, GPIO2, and GPIO3 as a whole can be thought of as the frequency identification result generated by the frequency identification module 120. If the carrier frequency of the audio second IF signal is around 5.5 MHz, the signal GPIO1 will be at a high voltage level while both the signals GPIO2 and GPIO3 will be at a low voltage level. At this time the determination module 190 determines that the TV standard, which a channel operates, is the PAL-B/G standard. If the carrier frequency of the audio second IF signal is around 6 MHz, the signal GPIO2 will be at the high voltage level while both the signals GPIO1 and GPIO3 will be at the low voltage level. At this time the determination module 190 determines that the TV standard, which a channel operates, is the PAL-I standard. If the carrier frequency of the audio second IF signal is around 6.5 MHz, the signal GPIO3 will be at the high voltage level while both the signals GPIO1 and GPIO2 will be at the low voltage level. At this time the determination module 190 determines that the TV standard, under which a channel operates, is the PAL-D/K standard. It should be appreciated that the determination module 190 can be realized by hardware, software, or a combination thereof.

In contrast to the related art, a TV standard is set for a channel by automatic determination rather than by manual operation. Even for a TV channel supporting Analog 2-Carrier (A2) or Near Instantaneous Companded Audio Multiplex (NICAM) sound effect, the TV standard of the TV channel can still be determined easily.

Those skilled in the art will readily observe that numerous modifications and alterations of the device and method may be made while retaining the teachings of the invention. Accordingly, the above disclosure should be construed as limited only by the metes and bounds of the appended claims.

1. An apparatus for automatically determining a TV standard of a TV channel, the apparatus comprising:
a frequency identification module for identifying a carrier frequency of an audio IF signal of the TV channel to generate a frequency identification result; and
a determination module coupled to the frequency identification module, for determining the TV standard of the TV channel according to the frequency identification result.

2. The apparatus of claim 1, wherein the frequency identification module comprises:
a filter module for filtering the audio IF signal to generate a plurality of filtered signals;
a conversion module coupled to the filter module, for converting the filtered signals into a plurality of resulting signals respectively; and
a comparison module coupled to the conversion module, for generating the frequency identification result according to the resulting signals.

3. The apparatus of claim 2, wherein the comparison module compares a reference signal with the resulting signals to generate the frequency identification result.

4. The apparatus of claim 2, wherein the comparison module compares the resulting signals with each other to generate the frequency identification result.

5. The apparatus of claim 1, wherein the determination module determines that the TV channel is operating pursuant to a PAL-B/G standard if the frequency identification result shows that the carrier frequency of the audio IF signal is around an audio carrier frequency of the PAL-B/G standard.

6. The apparatus of claim 5, wherein the audio IF signal is an audio second IF signal of the TV channel, and the audio carrier frequency is 5.5 MHz defined by the PAL-B/G standard.

7. The apparatus of claim 1, wherein the determination module determines that the TV channel is operating pursuant to a PAL-I standard if the frequency identification result shows that the carrier frequency of the audio IF signal is around an audio carrier frequency of the PAL-I standard.

8. The apparatus of claim 7, wherein the audio IF signal is an audio second IF signal of the TV channel, and the audio carrier frequency is 6 MHz defined by the PAL-I standard.

9. The apparatus of claim 1, wherein the determination module determines that the TV channel is operating pursuant to a PAL-D/K standard if the frequency identification result shows that the carrier frequency of the audio IF signal is around an audio carrier frequency of the PAL-D/K standard.

10. The apparatus of claim 9, wherein the audio IF signal is an audio second IF signal of the TV channel, and the audio carrier frequency is 6.5 MHz defined by the PAL-D/K standard.

11. The apparatus of claim 1, further comprising:
an IF amplifier coupled to the frequency identification module, for amplifying the audio IF signal of the TV channel.

12. A method for automatically determining a TV standard of a TV channel, comprising:
identifying a carrier frequency of an audio IF signal of the TV channel; and
determining the TV standard of the TV channel according to a frequency identification result of the identifying step.

13. The method of claim 12, wherein identifying the carrier frequency of the audio IF signal of the TV channel comprises:
filtering the audio IF signal to generate a plurality of filtered signals;
converting the filtered signals into a plurality of resulting signals respectively; and
generating the frequency identification result according to the resulting signals.

14. The method of claim 13, wherein generating the frequency identification result according to the resulting signals comprises:
comparing a reference signal with the resulting signals to generate the frequency identification result.

15. The method of claim 13, wherein generating the frequency identification result according to the resulting signals comprises:
comparing the resulting signals with each other to generate the frequency identification result.

16. The method of claim 12, wherein determining the TV standard of the TV channel according to the frequency identification result of the identifying step comprises:
determining that the TV channel is operating pursuant to a PAL-B/G standard if the frequency identification result shows that the carrier frequency of the audio IF signal is around an audio carrier frequency of the PAL-B/G standard.

17. The method of claim 16, wherein the audio IF signal is an audio second IF signal of the TV channel, and the audio carrier frequency is 5.5 MHz defined by the PAL-B/G standard.

18. The method of claim 12, wherein determining the TV standard of the TV channel according to the frequency identification result of the identifying step comprises:
determining that the TV channel is operating pursuant to a PAL-I standard if the frequency identification result shows that the carrier frequency of the audio IF signal is around an audio carrier frequency of the PAL-I standard.

19. The method of claim 18, wherein the audio IF signal is an audio second IF signal of the TV channel, and the audio carrier frequency is 6 MHz defined by the PAL-I standard.

20. The method of claim 12, wherein determining the TV standard of the TV channel according to the frequency identification result of the identifying step comprises:
determining that the TV channel is operating pursuant to a PAL-D/K standard if the frequency identification result shows that the carrier frequency of the audio IF signal is around an audio carrier frequency of the PAL-D/K standard.

21. The method of claim 20, wherein the audio IF signal is an audio second IF signal of the TV channel, and the audio carrier frequency is 6.5 MHz defined by the PAL-D/K standard.

22. The method of claim 12, further comprises:
amplifying the audio IF signal of the TV channel.

23. An apparatus for automatically determining a TV standard of a TV channel, comprising:
an IF amplifier comprising one or more of resistors, capacitors, inductors, and transistor;
a plurality of narrowband filters;
a plurality of conversion units comprising one or more of resistors, capacitors, and transistor;
a plurality of resistors; and
a plurality of comparison units, wherein the IF amplifier is coupled to the narrowband filters; each of the narrowband filters are coupled to one conversion unit, respectively; each of the resulting signals from the conversion units is a DC voltage; each comparison unit comprising a plurality of resistors and a voltage comparator, and each comparison unit is arranged in the form of a voltage divider; and a frequency identification result is produced from the comparison units.
